(19) United States
(12) Patent Application Publication
(10) Pub. No.: US 2021/0162973 A1
(43) Pub. Date: Jun. 3, 2021

(54) BRAKING SYSTEM HAVING A CORRECTION DEVICE FOR CORRECTING AN OPENING TIME OF A VALVE AND METHOD FOR CORRECTING THE OPENING TIME OF THE VALVE

(71) Applicant: KNORR-BREMSE Systeme für Nutzfahrzeuge GmbH, Munich (DE)

(72) Inventors: Severin HARTL, Geltendorf (DE); Thomas RASEL, Höhenkirchen-Siegertsbrunn (DE)

(21) Appl. No.: 16/954,070

(22) PCT Filed: Dec. 13, 2018
(86) PCT No.: PCT/EP2018/084692

§ 371 Date: Jun. 15, 2020

(30) Foreign Application Priority Data
Dec. 15, 2017 (DE) 10 2017 222 954.3

(51) Int. Cl. B60T 13/68; B60T 13/26; B60T 8/171; B60T 8/172

(52) U.S. Cl. CPC B60T 13/683; B60T 8/172; B60T 8/171; B60T 13/26

(57) ABSTRACT

A braking system has a correction device for correcting an opening time of a valve. The correction device includes a correction time determination apparatus, which determines a correction time as a difference between a most recently input effective valve opening time and an effective reference system valve opening time. An addition apparatus adds up the correction times after a current effective valve opening time to form a summed correction time, and a signal output for the summed correction time.

### CROSS REFERENCE AND PRIORITY CLAIM

This patent application is a U.S. National Phase of International Patent Application No. PCT/EP2018/084692 filed Dec. 13, 2018, which claims priority to German Patent Application No. 10 2017 222 954.3, the disclosure of which being incorporated herein by reference in their entireties.

### FIELD

Disclosed embodiments relates to a brake system includes a correction apparatus for an opening time of a valve and to a method for correcting the opening time of the valve, and in particular to a brake system for rail vehicles.

### BACKGROUND

Brakes of rail vehicles are usually operated by a pneumatic brake system which is actuated by a control or regulation device. In order to realize the function of the brake system, model-based pressure control or regulation systems are created on the development side. In the process, effective valve opening times, that is to say times at which the valve is actually open, for a desired change in a target pressure are calculated. Characteristic variables, that is to say parameters, of a pneumatic section, such as the volume and the pneumatic conductance for example, are used for the calculation.

In this case, when using pressure controllers, the pressure can remain at an operating point or move away from this operating point too slowly in the case of unfavorable valve behavior or unsuitable parameterization. When using model-based pressure regulation systems, incorrect parameterization with respect to the pneumatic section can result in excessively small or excessively large changes in pressure for each regulation process. As a result, multiple switching operations, reduced regulation accuracy, reduced regulation speed or instability can result.

For this reason, the characteristic variables of the pneumatic section were ascertained on the basis of construction data up until now, or the pneumatic system was designed specifically for defined pneumatic characteristic variables. Furthermore, the pneumatic timing behavior, specifically the loading and venting time, for a desired change in pressure was tested and the required parameters for the actuation function were ascertained on the basis of these test results. However, in this case, a large variety of variants to be tested could result owing to different components in the case of modular systems.

Disclosed embodiments eliminate the conventional disadvantages and of providing an apparatus and a method which ensure a required effective valve opening time in a pneumatic brake system even in the case of inaccurate design pre-specifications or a change in the actual pneumatic system.

### BRIEF DESCRIPTION OF THE FIGURES

A principle and an exemplary embodiment are shown below with reference to the appended drawings, in which:

FIG. 1 shows a basic design of a brake system according to the disclosed embodiments, and

FIG. 2 shows a design of a brake system comprising an embodiment of the correction apparatus according to the disclosed embodiments.

### DETAILED DESCRIPTION

The brake system according to disclosed embodiments includes comprising the correction apparatus for a valve opening time has a signal input interface for a signal of a most recently input effective valve opening time for the valve of the pneumatic brake system from a control system. The control system pre-specifies a predetermined effective valve opening time, with which the valve is actuated and which is input into the correction apparatus via the signal input interface, for a desired change in pressure in the pneumatic brake system, that is to say for initiating or amplifying, or reducing or canceling, a braking effect.

The brake system also contains a signal input interface for a pressure upstream of the valve after the most recently input effective valve opening time. The pressure upstream of the valve, that is to say on a side of the valve that is averted from a brake, is detected by means of a pressure sensor and a corresponding pressure signal for a pressure upstream of the valve is input into the apparatus via the signal input interface.

The brake system according to the disclosed embodiments furthermore contains a signal input interface for a pressure difference between a pressure after a current pre-specification of the effective valve opening time downstream of the valve and a pressure after the most recently input pre-specification of the effective valve opening time downstream of the valve.

The brake system according to the disclosed embodiments further has a valve opening time determination device which determines an effective reference system valve opening time from the pressure difference downstream of the valve, the pressure upstream of the valve after the most recently input pre-specification of the effective valve opening time and a parameter of the reference system.

This parameter is based substantially on a pneumatic configuration of a brake system. The parameter is ascertained in advance for a correspondingly predetermined pneumatic reference system, wherein the parameter is selected, for example, as a maximum, or alternatively for example in accordance with the actual brake system. A maximum means that a volume of the pneumatic system is at an upper limit and valve reaction times are at a “slow” tolerance limit. This means that an increase in pressure during a valve opening time is slow and the resulting change in pressure is therefore small or, as viewed from the other side, that a longer valve opening time is required in order to obtain a predetermined pressure difference. In the case in which the parameter represents the actual brake system, an effective valve opening time of the reference system for a predetermined pressure difference corresponds to the theoretical effective valve opening time of the actual brake system for this pressure difference. The parameter can also be a parameter space, wherein different parameters are used for different pressure differences.

The effective reference system valve opening time is that effective valve opening time which is determined on the basis of the parameter or of the parameter space, which defines the pneumatic properties of the reference system, from the pressure difference downstream of the valve and the pressure upstream of the valve after the most recently input pre-specification of the effective valve opening time for the reference system. As indicated above, the effective reference system valve opening time is influenced by the choice of the predetermined pneumatic reference system.

The brake system according to the disclosed embodiments furthermore also contains a correction time determination device which determines a correction time from a difference between the effective valve opening time most recently input by the control apparatus and the effective reference system valve opening time. By way of example, the correction time can correspond to the difference.

The correction time is used in order to correct the pre-specified effective valve opening time such that the pressure difference which is to be achieved by the pre-specified effective valve opening time is achieved.

This results from the following fundamental consideration:

On account of the effective valve opening time which is pre-specified by the control apparatus, a real pressure difference downstream of the valve in the real system is produced before and after the pre-specified effective valve opening time is input. If this real pressure difference is now input into the reference system, a virtual effective reference system valve opening time is calculated for this real pressure difference by means of the reference system. This virtual effective reference system valve opening time indicates the length of time for which the valve was virtually open according to the reference system in order to implement this real pressure difference.

The assumption is then that the reference system corresponds to a theoretical real brake system.

The case in which the virtual effective reference system valve opening time is shorter than the pre-specified effective valve opening time is considered first.

This firstly means that the real system does not correspond to the theoretical real system (the reference system) since otherwise the effective reference system valve opening time would correspond to the pre-specified effective valve opening time. This also means that the real pressure difference created from the effective valve opening time corresponds to a pressure difference which was created in the reference system from a shorter virtual effective valve opening time (specifically the effective reference valve opening time), on account of, for example, a fault in the real system. This real pressure difference is therefore smaller than the pressure difference expected in accordance with the pre-specified effective valve opening time. Therefore, the pre-specified effective valve opening time has to be extended in order to achieve the actually expected pressure difference. The difference between the effective valve opening time and the effective reference valve opening time is used as an approximation for a correction time.

No correction is required in a case in which the virtual effective reference system valve opening time corresponds to the effective valve opening time.

In the case in which the virtual effective reference system valve opening time is longer than the pre-specified effective valve opening time, it can be concluded from this that the real pressure difference is greater than intended, so that a correction by means of the correction time would possibly be required here, and the pre-specified effective valve opening time could be shortened.

The brake system according to the disclosed embodiments further contains an addition device which adds up the correction times to form an added-up correction time, so that the effective valve opening time approximates the actually required valve opening time in further actuation cycles.

Finally, the brake system according to the disclosed embodiments also has a signal output by means of which the added-up correction time is output to the control system.

In one refinement, the brake system is optionally provided with a signal input interface for a pressure after the most recently input effective valve opening time downstream of the valve. Here, a pressure downstream of the valve, that is to say on a side of the valve that faces the brake, is detected by means of a pressure sensor and a corresponding pressure signal for a pressure downstream of the valve is input via the signal input interface.

This refinement is further provided with a signal input interface for a pressure after the currently input effective valve opening time downstream of the valve.

A storage device in which a parameter, which defines the pneumatic properties of a reference system, is stored is also provided.

The brake system according to the disclosed embodiments is also provided with a storage device which stores the pressure upstream of the valve after the most recently input pre-specification of an effective valve opening time in order to make it available at a given time.

Furthermore, the brake system according to the disclosed embodiments is provided with a storage device which stores the pressure downstream of the valve after the most recently input pre-specification of an effective valve opening time in order to make it available at a given time.

The brake system of this refinement furthermore has a calculation device which calculates a pressure difference downstream of the valve between the pressure after the currently input effective valve opening time and a pressure after the most recently input effective valve opening time in order to provide the pressure difference for the valve opening time determination device.

In a further refinement of the brake system, the parameter optionally contains a valve characteristic. The actual system is represented more precisely in the reference system by taking into account, for example, a maximum valve cross section, a valve opening speed and/or a valve closing speed.

In a further or alternative refinement of the brake system, the parameter optionally contains a volume of the brake system downstream of the valve. The actual system is represented more precisely in the reference system by taking into account the volume of the brake system downstream of the valve.

In a further or alternative refinement of the brake system, the parameter optionally contains a pneumatic conductance. The actual system is represented more precisely in the reference system by taking into account the pneumatic conductance.

In a further refinement of the brake system, the parameter is optionally defined such that pneumatic properties (a “pneumatic increase”) of the reference system correspond to those of the pneumatic system.

Provided that the reference system at least approximately corresponds to the real brake system, it is possible in this refinement for the correction, as mentioned above, for the effective valve opening time to take place within one time step. It is further possible here, both in the case of an excessively low effective valve opening time and in the case of an excessively long effective valve opening time, to achieve the desired change in pressure in order to firstly ensure the function and secondly to keep consumption of air low.

In a further refinement of the apparatus, the parameter is optionally defined such that the pneumatic properties of the reference system correspond to a slowest acceptable pneumatic system.

In the case of a pressure difference which is measured after a pre-specified effective valve opening time is input, the reference system produces a virtual effective reference opening time which corresponds to the effective valve opening time of an actual slowest system. The virtual effective valve opening time therefore corresponds here to the longest time which can be required in order to achieve the desired pressure difference. If the effective valve opening time now approximates this virtual effective valve opening time, it is ensured that a functionally sufficient minimum change in pressure is achieved.

In a method according to the disclosed embodiments for correcting a valve opening time of a valve in a pneumatic brake system, a reference system with a parameter, which defines the pneumatic properties of the reference system, is initially determined. In this case, as mentioned above, it is possible to select the parameter in respect of specific reference systems. By way of example, the slowest acceptable reference system, or a reference system which corresponds to the theoretical actual system, can be selected.

Then, after the most recently input pre-specification of an effective valve opening time or possibly in the event of a first braking operation before a first pre-specification of the effective valve opening time, a pressure in the brake system upstream of the valve is detected and stored and a pressure in the brake system downstream of the valve is detected and stored. For a braking process for which the control system determines the effective valve opening time, the valve is actuated with this effective valve opening time. Subsequently, after the currently input pre-specification of the effective valve opening time, the pressure in the brake system downstream of the valve is detected once again and a pressure difference downstream of the valve between the pressure after the currently input pre-specification of the effective valve opening time and the pressure after the most recently input pre-specification of the effective valve opening time is determined. The effective reference valve opening time is then defined from the pressure difference in the brake system downstream of the valve, the pressure in the brake system after the most recently input pre-specification of the effective valve opening time upstream of the valve and the parameter which defines the pneumatic properties of the reference system. A correction time is then determined depending on a difference between the effective valve opening time and the effective reference valve opening time.

Said correction time can be, for example, a fixed time value which has a positive or negative sign depending on whether the effective valve opening time is greater than the effective reference valve opening time or the effective valve opening time is smaller than the effective reference valve opening time. This correction time is then added to an added-up correction time and the added-up correction time is output, wherein the effective valve opening time which is output by the control system is then corrected with the added-up correction time.

Both an unsuitable effective opening time of the valve and a “pneumatic increase” which deviates from the reference system can be compensated for by means of the correction time. Provided that the actual “pneumatic increase” corresponds to that of the reference system, the effective opening time is compensated for within one step, i.e. after a single pre-specification of the effective valve opening time.

Parameterization of the software in respect of the speed of the pneumatic system is also not absolutely necessary. It is only necessary to ensure that the speed of the pneumatic system to be controlled or to be regulated lies within defined limits.

In an advantageous development of the method, the correction time is determined as a difference between the effective valve opening time and the effective reference valve opening time. As a result, it is possible to match the effective valve opening time as quickly as possible to the effective reference valve opening time, so that a reliable function is quickly achieved.

According to a further advantageous development of the method, a starting value for the effective valve opening time with a time constant which corresponds to a quickest expected pneumatic system, this resulting in a shortest-possible valve opening time, is determined. The result of this is that a pressure downstream of the valve does not increase to an excessive extent in a first cycle of the correction method (so that it may even lie above a maximum required pressure in the worst case), wherein it is possible to approximate the actually required pressure without overshooting, and the approximation takes place rapidly and consumption of air is lower.

If, according to an advantageous development of the method, the parameter of the reference system is selected such that it corresponds to an actual pneumatic system, the correction can take place such that the effective valve opening time corresponds to the effective reference valve opening time, this preventing an excessively high pressure being present downstream of the valve and therefore reducing the consumption of compressed air.

In an alternative advantageous development of the method, the parameter of the reference system is selected such that it corresponds to a slowest acceptable pneumatic system. Here, the effective reference valve opening time is selected to be as long as possible by means of the reference system, so that the effective valve opening time, owing to the correction time, assumes a value which ensures that a functionally sufficient minimum for the change in pressure is achieved.

In a further advantageous development of the method, a function which represents the relationship between an actuation period and the effective valve opening time is taken into account. This relationship can be expressed either by a linear function or else increase in an overproportional or underproportional manner. In this case, only this relationship has to be adjusted in the event of valve exchange.

According to an advantageous development of the method, with each signal of an effective valve opening time in the case of which a direction of the change in pressure remains the same, that is to say in the case of which the pressure in the pneumatic system is either continuously increased or alternatively continuously reduced, the correction value is ascertained in the apparatus and added up, so that the effective valve opening time approaches the actually required effective valve opening time. Here, the effective valve opening time is matched to the current state of the brake system with each braking process and each time the brake system is vented. This ensures that, in addition to structural influences on the valve opening time, currently occurring changes are also taken into consideration.

In accordance with an advantageous development of the method, the added-up correction value is reset to zero when a changeover in brake actuation is made from loading to venting or from venting to loading. It is ensured here that the effective valve opening time is corrected as quickly as possible to the actually required valve opening time, without an excessively high brake pressure, which would cause an excessive braking action, occurring.

In an advantageous development of the method, the method is executed using an apparatus according to the disclosed embodiments.

Braking and releasing a brake of a brake system is performed by a control device of the brake system outputting pulses. In this case, a braking process is triggered by outputting a first braking pulse over a certain time period, from which an effective valve opening time follows, during which the brake system is loaded. For the purpose of changing the braking force, a further braking pulse is then output for an effective valve opening time, by means of which braking pulse the brake system is further loaded, that is to say the pressure on the brake is increased, or by means of which braking pulse the brake system is vented, that is to say the pressure on the brake is reduced. A state after the further braking pulse and after all subsequent braking pulses is referred to as “after a currently input effective valve opening time” in the text which follows. The state after the first braking pulse and after the directly before the further currently input effective valve opening times is referred to as “after a most recently input effective valve opening time” in the text which follows. When the first braking pulse is interpreted as the current valve opening time, the state before the first braking pulse is considered to be the state after the most recently input effective opening time.

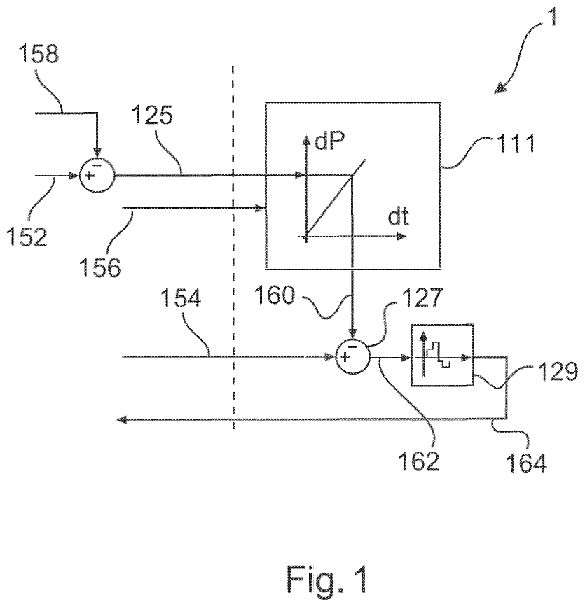

FIG. 1 shows a basic design of a correction apparatus 1 according to the disclosed embodiments in a brake system for actively monitoring a pre-specified effective valve opening time and for correction of the pre-specified effective valve opening time.

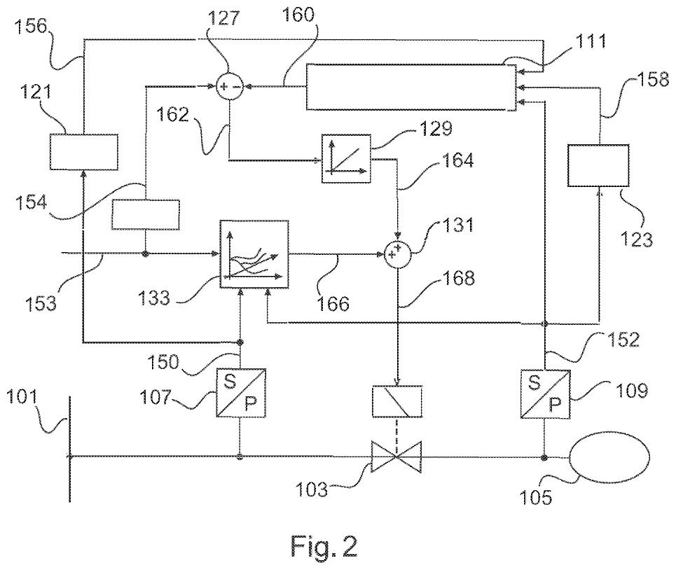

The correction apparatus 1 has an input for a pressure difference 125 between a pressure 152 downstream of a valve 103 (FIG. 2) after a currently input effective valve opening time 153 (FIG. 2) and a pressure 158 downstream of the valve 103 (FIG. 2) after a most recently input effective valve opening time 154.

The correction apparatus 1 also has an input for a pressure 156 upstream of the valve 103 (FIG. 2) after the most recently input effective valve opening time 154.

A reference system 111 is further provided in the correction apparatus 1 at a tolerance edge of a “slowest system”, which reference system determines an effective reference valve opening time 160 from a parameter, which defines the pneumatic properties of a reference system 111, the pressure difference 125 and the pressure 156 upstream of the valve 103 (FIG. 2) before the most recently input effective valve opening time 154.

Furthermore, the correction apparatus 1 has a correction time determination device 127 which determines a correction time 162 (FIG. 2) from the difference between the effective reference valve opening time 160 and the most recently input effective valve opening time 154.

The correction apparatus 1 is also provided with an addition device 129 which adds up the correction times 162 after each pre-specification of the effective valve opening time to form an added-up correction time 164.

Finally, the correction apparatus 1 is provided with a signal output for outputting the added-up correction time 164 to the system controller.

After each actuating process, that is to say after the renewed pre-specification of the effective valve opening time, the correction apparatus 1 determines the effective reference valve opening time 160 for a reference system 111 at the tolerance limit, at which the increase in pressure during the valve opening time is at a minimum, from the pressure difference 125 downstream of the valve 103 (FIG. 2) between the pressure 152 after the currently input effective valve opening time 153 (FIG. 2) and the pressure 158 after the most recently input effective valve opening time 154, the pressure 156 upstream of the valve 103 (FIG. 2) after the most recently input effective valve opening time 154 and the parameter which defines the pneumatic properties of a reference system. This effective reference valve opening time 160 indicates the length of time for which a valve of the theoretical reference system was virtually open in order to implement the measured change in pressure. The most recently pre-specified effective valve opening time 154 is compared with the calculated effective reference valve opening time 160, and the difference is used to determine whether the actuation period of the last effective valve opening time 154 was suitable. In the event of a deviation between the most recently input effective valve opening time 154 and the calculated effective reference valve opening time 160, a correction time 162 is calculated and added up for each cycle in the addition device 129 as the added-up correction time 164. The added-up correction time 164 is then made available to the control apparatus for correcting the next pre-specified effective valve opening time.

FIG. 2 shows a design of an embodiment of the brake system comprising the correction apparatus 1.

The brake system has a pressure line 101 for feeding a supply pressure. The valve 103, which is connected to the pressure line 101, is also provided in order to supply a volume 105, which is located downstream of the valve 103, for a desired braking effect with a desired pressure. A pressure sensor 107 is provided upstream of the valve 103, that is to say on the side of the pressure line 101 starting from the valve 103, in order to detect a pressure 150 upstream of the valve 103. A further pressure sensor 109 is provided downstream of the valve 103, that is to say on the side of the volume 105 starting from the valve 103, in order to detect a pressure 152 downstream of the valve 103.

The brake system is provided with a signal input interface for a pre-specification of the current effective valve opening time 153, with a signal input interface for the pressure 150 upstream of the valve 103 and a signal input interface for the pressure 152 downstream of the valve 103. The brake system is also provided with a storage device for the parameter which defines the pneumatic properties of a reference system 111. Furthermore, the brake system is provided with a storage device 121 for storing the pressure 156 upstream of the valve 103 after the most recently input effective valve opening time 154 and with a storage device 123 for storing the pressure 158 downstream of the valve 103 after the most recently input effective valve opening time 154.

The brake system also has a calculation device which calculates the pressure difference 125 (FIG. 1) between the pressure 158 downstream of the valve 103 after the most recently input effective valve opening time 154 and the pressure 152 downstream of the valve 103 after the currently input effective valve opening time 153.

A valve opening time determination device which determines the effective reference valve opening time 160 from the pressure difference 125 (FIG. 1) between the pressure 158 downstream of the valve 103 after the most recently input effective valve opening time 154 and the pressure 152 downstream of the valve 103 after the currently input effective valve opening time 153, the pressure 156 upstream of the valve 103 after the most recently input effective valve opening time 154 and the parameter, which defines the pneumatic properties of the reference system 111, is also provided in the brake system.

In addition, a correction time determination device 127, which determines a correction time 162 from a difference between the most recently input effective valve opening time 154 and the effective reference valve opening time 160, is contained in the correction apparatus 1.

An addition device 129, which adds up the correction times 162 after each currently input effective valve opening time 153 in an added-up correction time 164, is further also provided.

The brake system is also provided with a valve dynamics storage and calculation device 133 by means of which a preliminary actuating variable 166 is calculated from the pre-specification of the currently input effective valve opening time 153.

Finally, a further addition device 131, which adds the preliminary actuating variable 166 to the added-up correction time 164 and then outputs a final actuating variable 168 to the valve 103 based on the effective valve opening time 154, is also provided in the brake system.

A starting value for a currently input effective valve opening time 153 is pre-specified by the control apparatus. This starting value for the currently input effective valve opening time 153 is optionally determined with a time constant which corresponds to a quickest expected pneumatic system, this resulting in a shortest-possible currently input effective valve opening time 153. The result of this is that a pressure downstream of the valve 103 does not increase to an excessive extent in a first cycle of the correction method, wherein it may even lie above a maximum required pressure, so that it is possible to approximate the actually required pressure without overshooting, the approximation takes place rapidly and consumption of compressed air is lower.

The preliminary actuating variable 166 is calculated from the currently input effective valve opening time 153 by the valve dynamics storage and calculation device 133 for valve dynamics on the basis of the known valve dynamics.

The preliminary actuating variable 166 is added to the added-up correction time 164 by the further addition device 131 and output to the valve 103 as the final actuating variable 168.

The added-up correction time 164 is calculated from the correction times 162, which are determined for the individual pre-specified effective valve opening times, by the addition device 129. The added-up correction time 164 is reset to zero in the event of a change in direction of the actuation, when a changeover in brake actuation is made from loading to venting or from venting to loading. The value of the added-up correction time 164 remains the same when the pressure in the volume 105 is merely maintained between two pre-specified effective valve opening times.

The correction times 162 are once again formed from the difference between the most recently input effective valve opening time 154 and the effective reference valve opening time 160 by the correction time determination device 127.

The effective reference valve opening time 160 is determined from the pressure difference 125 (FIG. 1) between the pressure 158 downstream of the valve 103 after the most recently input effective valve opening time 154 and the pressure 152 downstream of the valve 103 after a currently input effective valve opening time 153, the pressure 156 upstream of the valve 103 after the most recently input effective valve opening time 154 and the parameter, which defines the pneumatic properties of the reference system 111, at the tolerance limit in the reference system 111.

### LIST OF REFERENCE SIGNS

1 Correction apparatus
101 Pressure line
103 Valve
105 Volume
107 Pressure sensor
109 Pressure sensor
111 Reference system
121 Storage device
123 Storage device
125 Pressure difference
127 Correction time determination device
129 Addition device
131 Addition device
133 Valve dynamics storage and calculation device
150 Pressure upstream of the valve after a currently input effective valve opening time
152 Pressure downstream of the valve after a currently input effective valve opening time
153 Current pre-specification of the effective valve opening time
154 Most recently input pre-specification of the effective valve opening time
156 Pressure upstream of the valve after the most recently input effective valve opening time
158 Pressure downstream of the valve after the most recently input effective valve opening time
160 Effective reference valve opening time
162 Correction time
164 Added-up correction time
166 Preliminary actuating variable
168 Final actuating variable

1. A brake system comprising a correction apparatus for an opening time of a valve of the pneumatic brake system, the correction apparatus comprising:
a signal input interface for a signal of a most recently input effective valve opening time;
a signal input interface for a pressure upstream of the valve after the most recently input effective valve opening time;
a signal input interface for a pressure difference between a pressure after a current pre-specification of the effective valve opening time downstream of the valve and a pressure after the most recently input pre-specification of the effective valve opening time downstream of the valve;
a valve opening time determination device which is configured to determine an effective reference system valve opening time from the pressure difference downstream of the valve, the pressure after the most recently input pre-specification of the effective valve opening time upstream of the valve and a parameter of a reference system, which parameter defines the pneumatic properties of the reference system;
a correction time determination device which is configured to determine a correction time from a difference between the most recently input effective valve opening time and the effective reference system valve opening time;
an addition device which is configured to add up the correction times after a current effective valve opening time to form an added-up correction time; and
a signal output for the added-up correction time with which the current effective valve opening time is corrected.

2. The brake system of claim 1, further having
a signal input interface for a signal of the current effective valve opening time for the valve of the pneumatic brake system,
a signal input interface for the pressure downstream of the valve after the most recently input effective valve opening time,
a signal input interface for a pressure downstream of the valve after the currently input effective valve opening time 153,
a storage device in which the parameter which defines the pneumatic properties of a reference system is stored,
a storage device which stores the pressure after the most recently input prespecification of the effective valve opening time upstream of the valve,
a storage device which stores the pressure after the most recently input prespecification of the effective valve opening time downstream of the valve, and
a calculation device which calculates a pressure difference between the pressure downstream of the valve and the pressure after the most recently input prespecification of the effective valve opening time downstream of the valve.

3. The brake system of claim 1, wherein
the parameter of the reference system contains a valve characteristic and/or a volume of the brake system downstream of the valve and/or a pneumatic conductance.

4. The brake system of claim 1, wherein
the parameter are defined such that the pneumatic properties of the reference system correspond to those of the pneumatic brake system.

5. The brake system of claim 1, wherein
the parameter is defined such that the pneumatic properties of the reference system correspond to those of a slowest permissible reference system.

6. A method for correcting a valve opening time of a valve in a pneumatic brake system, the method comprising:
determining a reference system with a parameter which defines the pneumatic properties of the reference system;
detecting and storing a pressure in the pneumatic brake system after a most recently input pre-specification of an effective valve opening time upstream of the valve;
detecting and storing a pressure in the pneumatic brake system after the most recently input pre-specification of the effective valve opening time downstream of the valve;
determining an effective current valve opening time using a control device;
actuating the valve with the effective valve opening time;
detecting the pressure in the pneumatic brake system after the currently input prespecification of the effective valve opening time downstream of the valve;
calculating a pressure difference between the pressure after the currently input prespecification of the effective valve opening time and the pressure after the most recently input prespecification of the effective valve opening time downstream of the valve;
determining the effective reference system valve opening time from the pressure difference downstream of the valve, the pressure after the most recently input pre-specification of the effective valve opening time upstream of the valve, and the parameter which defines the pneumatic properties of the reference system;
determining a correction time depending on a difference between the currently prespecified effective valve opening time and the effective reference system valve opening time;
adding up the correction time to form an added-up correction time;
outputting the added-up correction time; and
correcting the next prespecification of the effective valve opening time with the added-up correction time.

7. The method of claim 6, where the correction time is determined as a difference between the effective valve opening time and the effective reference valve opening time.

8. The method of claim 6, the method comprising determining a starting value of the effective valve opening time with a time constant which corresponds to a quickest expected pneumatic brake system.

9. The method of claim 6, wherein the parameter of the reference system is selected to correspond to an actual pneumatic system.

10. The method of claim 6, wherein the parameter of the reference system is selected to correspond to a slowest expected pneumatic system.

11. The method of claim 6, wherein a function which makes available the relationship between an actuation period and the effective opening time of the valve is taken into consideration.

12. The method of claim 6, wherein the connection time is added up each time a current effective valve opening time in which a direction of the change in pressure remains the same is input, so that the current effective valve opening time approximates the actually required valve opening time.

13. The method of claim 6, wherein the added-up correction time is reset to zero when a changeover in actuation is made from loading to venting or from venting to loading.

14. The method of claim 6, wherein the method is executed in a brake system that includes a correction apparatus for the opening time of a valve of the pneumatic brake system, wherein the correction apparatus includes a signal input interface for the signal of the most recently input effective valve opening time, a signal input interface for the pressure upstream of the valve after the most recently input effective valve opening time, a signal input interface for the pressure difference between the pressure after the current pre-specification of the effective valve opening time downstream of the valve and the pressure after the most recently input pre-specification of the effective valve opening time downstream of the valve, a valve opening time determination device which is configured to determine the effective reference system valve opening time from the pressure difference downstream of the valve, the pressure after the most recently input pre-specification of the effective valve opening time upstream of the valve and the parameter of the reference system, which parameter defines the pneumatic properties of the reference system, a correction time determination device which is configured to determine the correction time from the difference between the most recently input effective valve opening time and the effective reference system valve opening time, an addition device which is configured to add up the correction times after the current effective valve opening time to form the added-up correction time, and a signal output for the added-up correction time with which the current effective valve opening time is corrected.

15. The brake system of claim 2, wherein the parameter of the reference system contains a valve characteristic and/or a volume of the brake system downstream of the valve and/or a pneumatic conductance.

16. The brake system of claim 2, wherein the parameter are defined such that the pneumatic properties of the reference system correspond to those of the pneumatic brake system.

17. The brake system of claim 2, wherein the parameter is defined such that the pneumatic properties of the reference system correspond to those of a slowest permissible reference system.
